(19) United States
(12) Patent Application Publication
(10) Pub. No.: US 2026/0103942 A1
(43) Pub. Date: Apr. 16, 2026

(54) FRAMELESS HIDDEN wheel SLIDABLE DOOR

(71) Applicant: Foshan Lanfeilin Sanitary Ware Co., Ltd., Foshan (CN)

(72) Inventor: HAISHENG XIAO, Foshan (CN)

(21) Appl. No.: 18/914,745

(22) Filed: Oct. 14, 2024

Related U.S. Application Data
(63) Continuation-in-part of application No. 18/911,631, filed on Oct. 10, 2024.

(51) Int. Cl. E06B 3/46; E05D 15/06

(52) U.S. Cl. CPC E06B 3/4636; E05D 15/0626; E05Y 2900/132

(57) ABSTRACT

A frameless hidden wheel slidable door is provided, which includes a fixed mechanism and a slidable door, the fixed mechanism includes a fixed rail and shock absorbers provided at two ends of the fixed rail; one side of the fixed rail is provided with a guide groove along a length extension direction. The slidable door is slidably connected to the guide groove, and the shock absorbers are provided with a limit groove corresponding to the slidable door; and further include a guide mechanism configured to connect the slidable door and the guide groove. The guide mechanism includes at least one wheel that is cooperated with the guide groove and an installation seat that is connected to the slidable door and the wheel. The wheel is provided on one side of the slidable door; the installation seat includes an adjustment block and a connection shaft.

### CROSS-REFERENCE TO RELATED APPLICATIONS

This application is a continuation-in-part of U.S. patent application Ser. No. 18/911,631, filed on Oct. 10, 2024, which is hereby incorporated by reference in its entirety.

### TECHNICAL FIELD

The present disclosure relates to the field of bathroom door technologies, and in particular, to a frameless hidden wheel slidable door.

### BACKGROUND

Usually, bathroom doors are available in two forms: a rotatable swing type or a sliding type. A rotatable swing type bathroom door can be fully opened, but a space needs to be reserved for a door leaf to rotate when it is opened, rendering it suitable for situations with large spaces. In other words, sliding bathroom doors are more suitable for situations with smaller spaces because they do not require additional space when opened.

At present, slidable doors are generally installed with a suspension rail above a door opening, and the slidable door is suspended below the suspension rail through a wheel and a suspension rod. The wheel of such bathroom doors is usually exposed, which affects the aesthetics of the product; furthermore, such slidable doors usually have side frames set on both sides of the door opening. The setting of side frames will occupy the space of a passage after the slidable door is opened, thereby creating hygiene blind spots that are difficult to clean. Besides that, the side frames will affect a visual effect to a certain extent, which does not meet the modern people's pursuit of a minimalist style without side frames.

The technical problem to be solved by the present application is that how to solve problems of insufficient aesthetics, inconvenient cleaning, and high material costs of the existing sliding bathroom doors.

### SUMMARY

In order to overcome the shortcomings of existing technology, the purpose of the present disclosure is to provide a frameless hidden wheel slidable door, which has characteristics of simple structure, convenient cleaning, and simple and beautiful appearance.

The technical solution adopted by the present disclosure is: a frameless hidden wheel slidable door, which includes a fixed mechanism and a slidable door, the fixed mechanism includes a fixed rail and shock absorbers provided at two ends of the fixed rail; one side of the fixed rail is provided with a guide groove along a length extension direction, the slidable door is slidably connected to the guide groove, the shock absorbers are provided with a limit groove corresponding to the slidable door;
the frameless hidden wheel slidable door further includes a guide mechanism that is connected to the slidable door and the guide groove; the guide mechanism includes at least one wheel that is slid and cooperated with the guide groove and an installation seat that is connected to the slidable door and the wheel; the at least one wheel is provided on one side of the slidable door, the installation seat includes an adjustment block and a connection shaft; the slidable door is provided with an adjustment hole that is cooperated with the adjustment block, the connection shaft is eccentrically provided with the adjustment block; one end of the connection shaft that is far away from the adjustment block is connected to the at least one wheel.

In some embodiments, the installation seat further includes a fixed plate and an installation plate, the fixed plate is connected to one end of the adjustment block away from the at least one wheel, the installation plate is connected to one end of the connection shaft away from the adjustment block, the installation plate is provided with the at least one wheel, diameters of the fixed plate and the installation plate are larger than a diameter of the adjustment hole.

In some embodiments, the fixed mechanism further includes a fixed seat provided at two ends of the fixed rail, and the fixed seat is provided with an insertion slot corresponding to the fixed rail and an installation slot corresponding to the shock absorbers.

In some embodiments, the fixed seat includes a seat body and a locking plate, the insertion slot and the installation slot are provided on the seat body, and the insertion slot penetrates the seat body, the shock absorbers are provided in the installation slot, the locking plate is fixedly connected to an external wall, and the locking plate is detachably connected to the seat body.

In some embodiments, the fixed mechanism further includes a lower fixed seat provided at a bottom of the slidable door, and the lower fixed seat is provided with a sliding groove corresponding to the slidable door.

In some implementations, the frameless hidden wheel slidable door further includes a water blocking strip, which is provided on one side of the bottom of the slidable door.

In some implementations, two side edges of the slidable door is provided with a first waterproof strip.

In some embodiments, the fixed mechanism further includes a fixed door provided at one end of the fixed rail, a top of the fixed door is connected to the fixed rail, and one side edge of the fixed door abuts against the external wall.

In some embodiments, the fixed mechanism further includes a locking ground rail provided at the bottom of the fixed door.

In some embodiments, one side edge of the fixed door away from the wall is provided with a second waterproof strip, and the second waterproof strip is provided with a water blocking plate that is extended towards the slidable door.

The beneficial effects of the present application are: the frameless hidden wheel slidable door of the present application, by providing the wheel on a side of a top of the slidable door and correspondingly providing the guide groove on one side of the fixed rail, it is more convenient for installation and debugging. Only the adjustment block needs to be rotated to fine tune a relative height between the wheel and the slidable door. Furthermore, during a normal use, due to an obstruction of the slidable door and the fixed rail, the wheel can be hidden, which is more beautiful. Compared with the traditional arrangement of the wheel at top or bottom of the fixed rail, the slidable door in the present application only needs to meet a strength requirement of the fixed rail and a size of the guide groove that can accommodate the wheel, so that a height of the fixed rail can be minimized as much as possible, rendering the structure of the slidable door more simple and compact, besides that, a side frame provided by traditional slidable doors is eliminated, this further saves material costs, eliminates hygiene blind spots, facilitates cleaning, and meets a modern pursuit of minimalist frameless style.

### BRIEF DESCRIPTION OF DRAWINGS

FIG. 1 is a schematic structural diagram of a frameless hidden wheelslidable door according to an embodiment of the present disclosure.

FIG. 2 is a schematic structural diagram of the frameless hidden wheel slidable door shown in FIG. 1 from another perspective.

FIG. 3 is a schematic structural diagram of a sliding door, a fixed rail, and a guide mechanism in the frameless hidden wheel slidable door shown in FIG. 1.

FIG. 4 is a schematic diagram of a structural decomposition of the guide mechanism shown in FIG. 3.

FIG. 5 is a schematic structural diagram of a fixed seat, a shock absorber, and a fixed rail in the frameless hidden wheel slidable door shown in FIG. 2.

FIG. 6 is an exploded schematic structural diagram of the fixed seat and the shock absorber shown in FIG. 5.

FIG. 7 is a schematic diagram of a top view of the sliding door and a fixed door shown in FIG. 1.

FIG. 8 is a schematic structural diagram of a lower fixed seat, a locking rail, and a water blocking strip shown in FIG. 2.

FIG. 9 shows an application example of the frameless hidden wheel slidable door in the present application.

Numeral reference: 100-frameless hidden wheel slidable door; 10-fixed mechanism; 11-fixed rail; 111-guide groove; 112-first clamp groove; 12-shock absorber; 121-limit groove; 13-fixed seat; 131-insertion slot; 132-installation slot; 133-seat body; 134-locking plate; 14-lower fixed seat; 141-sliding groove; 15-fixed door; 151-second waterproof strip; 152-water blocking plate; 16-locking ground rail; 161-second clamp slot; 17-reinforcement member; 20-slidable door; 21-adjustment hole; 22-first waterproof strip; 23-handle; 30-guide mechanism; 31-wheel; 32-installation seat; 321-adjustment block; 322-connection shaft; 323-fixed plate; 324-installation plate; 325-extension shaft; 326-gasket; 327-locking screw; 40-water blocking strip.

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them. Based on the embodiments in the present disclosure, all other embodiments obtained by those skilled in the art without creative work are within the protection scope of the present disclosure.

It should be noted that when a component is referred to as “fixed to” another component, it can be directly on the other component or there can also be a centered component. When a component is considered to be “connected” to another component, it can be directly connected to another component or there may be a central component present at the same time. When the number of components is referred to “multiple”, it can be any number of two or more. Term “vertical”, “horizontal”, “left”, “right” and similar expressions used in this specification are for an illustrative purpose only and do not represent the implementation mode.

Unless otherwise defined, all technical and scientific terms used in this specification have the same meanings as those commonly understood by those skilled in the art belonging to the present disclosure. Terms used in the specification of the present disclosure are only for a purpose of describing specific embodiments and are not intended to limit the present disclosure. Term “and/or” used in this specification includes any and all combinations of one or more related listed items.

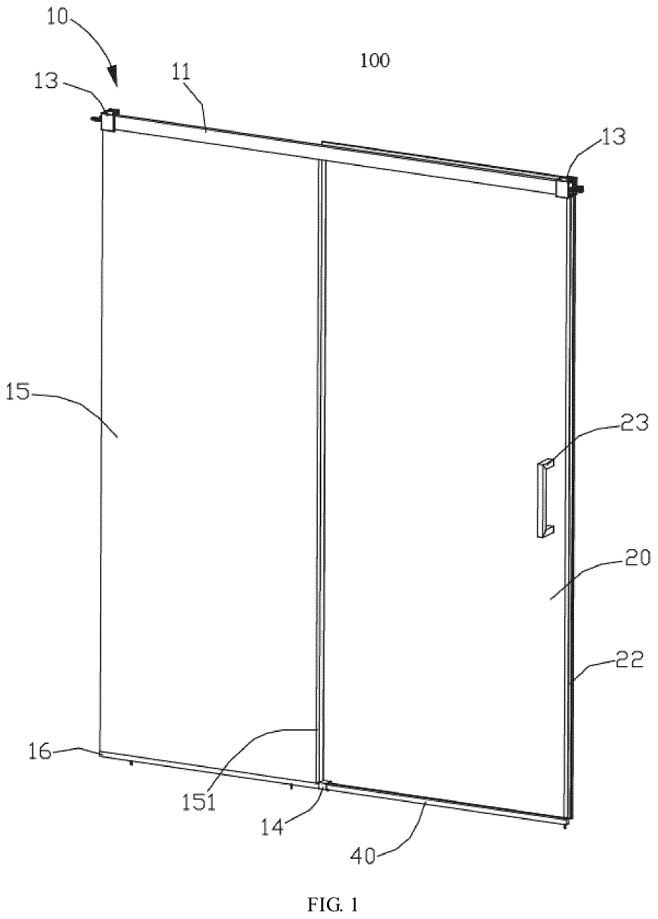

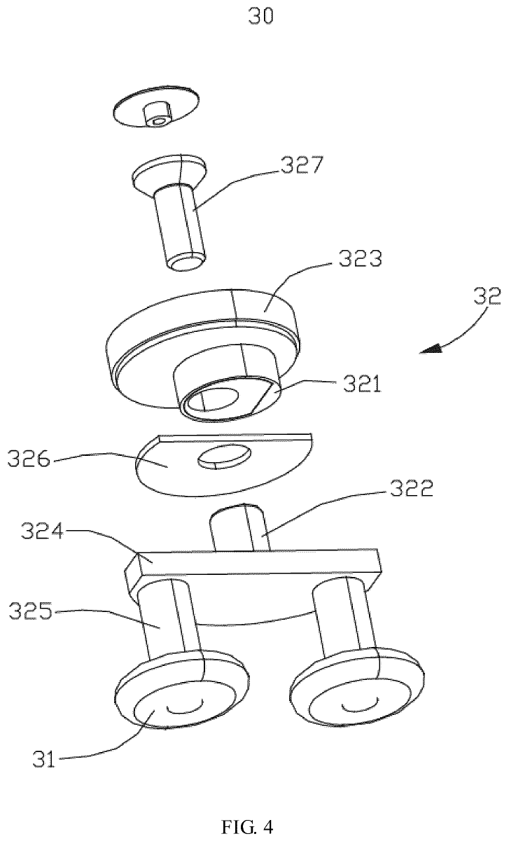

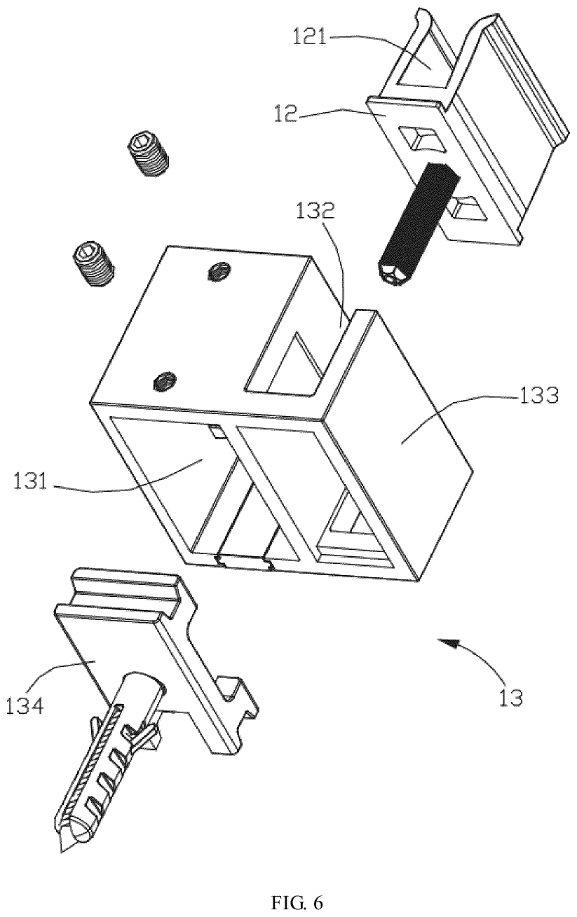

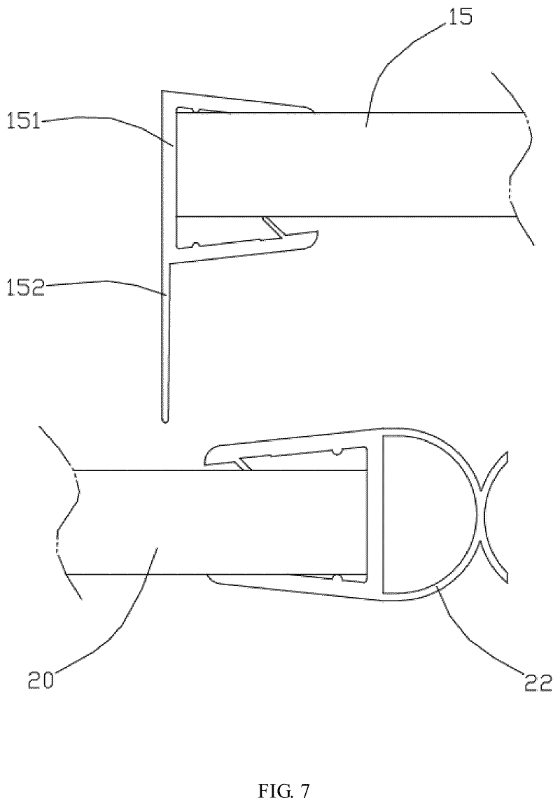

Please refer to FIGS. 1 to 8, which shows a frameless hidden wheel slidable door 100 according to an embodiment of the present disclosure. The frameless hidden wheel slidable door 100 includes a fixed mechanism 10 and a slidable door 20. The fixed mechanism 10 includes a fixed rail 11 and shock absorbers 12 provided at two ends of the fixed rail 11. One side of the fixed rail 11 is provided with a guide groove 111 along a length extension direction. The slidable door 20 is slidably connected to the guide groove 111, the shock absorbers 12 are provided with a limit groove 121 corresponding to the slidable door 20; the frameless hidden wheel slidable door 100 further includes a guide mechanism 30 that is connected to the slidable door 20 and the guide groove 111. The guide mechanism 30 includes at least one wheel 31 that is slid and cooperated with the guide groove 111 and an installation seat 32 that is connected to the slidable door 20 and the at least one wheel 31. The at least one wheel 31 is provided on one side of the slidable door 20, and the installation seat 32 includes an adjustment block 321 and a connection shaft 322. The slidable door 20 is provided with an adjustment hole 21 that is cooperated with the adjustment block 321. The connection shaft 322 is eccentrically provided with the adjustment block 321, one end of the connection shaft 322 away from the adjustment block 321 is connected to the at least one wheel 31.

The frameless hidden wheel slidable door 100 of the present application, by providing the wheel 31 on a top of a side of the slidable door 20 and corresponding providing the guide groove 111 on one side of the fixed rail 11. Thus, installation and debugging are also more convenient. Only the adjustment block 321 needs to be rotated to fine tune a relative height between the wheel 31 and the slidable door 20. Furthermore, during normal use, due to an obstruction of the slidable door 20 and the fixed rail 11, the wheel 31 can be hidden, which is more beautiful. Compared with a traditional arrangement of the wheel 31 that is provided at top or bottom of the fixed rail 11, the wheel door in the present application only needs to meet a strength requirement of the fixed rail 11 and a size of the guide groove 111 that can accommodate the wheel 31, so that a height of the fixed rail 11 can be maximized as possible, rendering the structure of the slidable door to be simpler and more compact, and also eliminating a side frame provided by the traditional slidable doors. This further saves material costs, eliminates hygiene blind spots, facilitates cleaning, and meets a modern pursuit of minimalist frameless style.

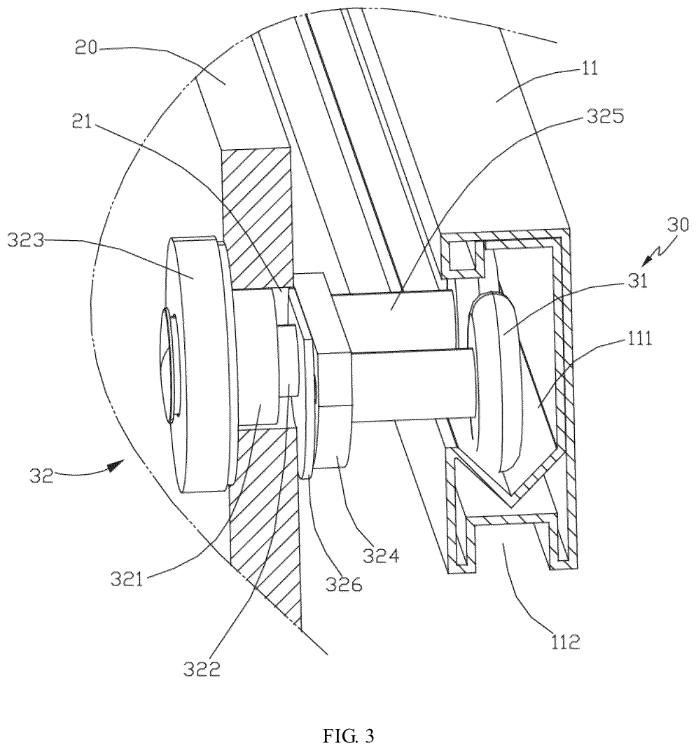

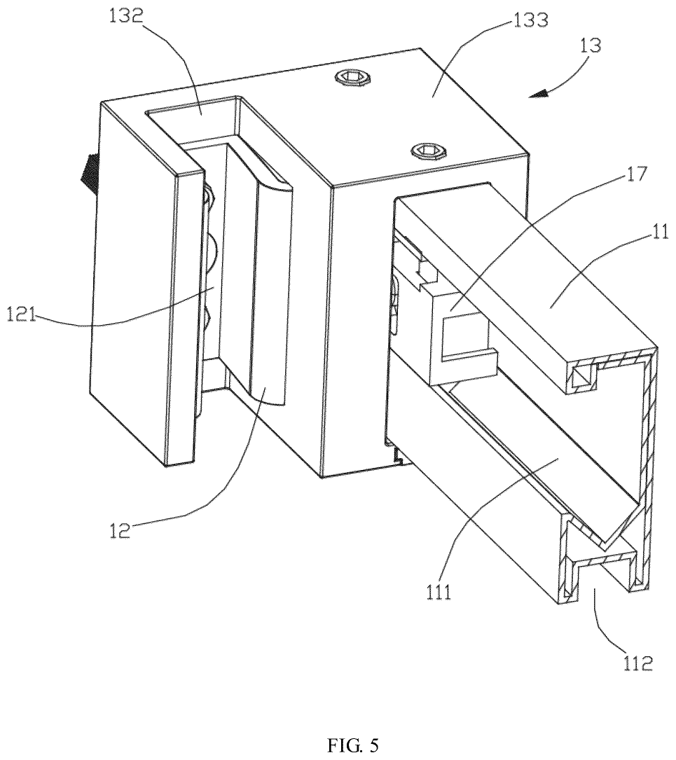

As shown in FIGS. 3 and 5, in this embodiment, an opening of the guide groove 111 is provided on one side of the fixed rail 11. In order to facilitate an installation of the wheel 31 into the guide groove 111 from the opening, a width of the opening of the guide groove 111 is slightly larger than a diameter of the wheel 31. At the same time, to avoid the wheel 31 from falling off from the opening during the normal use, a bottom of the guide groove 111 should be lower than a bottom of the opening. Furthermore, in this embodiment, a width of the bottom of the guide groove 111 gradually decreases from a direction close to the opening to a direction away from the opening, which can increase a contact area between an inner wall of the guide groove 111 and the wheel 31 so as to improve a sliding stability of the slidable door 20 during pushing and pulling process.

Due to an eccentric arrangement of the connection shaft 322 and the adjustment block 321, when it is necessary to adjust the relative height between the wheel 31 and the slidable door 20, the adjustment block 321 is needed to rotate so as to adjust the height of the wheel 31. In an implementation mode, the installation seat 32 further includes a fixed plate 323 and an installation plate 324. The fixed plate 323 is connected to one end of the adjustment block 321 away from the wheel 31, and the installation plate 324 is connected to one end of the connection shaft 322 away from the adjustment block 321. The installation plate 324 is provided with the at least one wheel 31, diameters of the fixed plate 323 and the installation plate 324 are larger than a diameter of the adjustment hole 21. By providing with the fixed plate 323 and the installation plate 324, it is possible to prevent the adjustment block 321 from coming out of the adjustment hole 21. In addition, in order to facilitate an adjustment of the height of the wheel 31 relative to the slidable door 20, the connection shaft 322 and the adjustment block 321 are connected by a locking screw 327. In order to avoid the installation plate 324 rotating along with the connection shaft 322 when adjusting an angle of the adjustment block 321, the connection shaft 322 and the installation plate 324 should be rotatably connected. In order to protect the slidable door 20 and prevent damage to the slidable door 20 when locking the locking screw 327, a gasket 326 is provided on one side of the installation plate 324 near the connection shaft 322. In an implementation mode, in order to facilitate the installation of the wheel 31, an extension shaft 325 is further provided on the installation seat 32, and two ends of the extension shaft 325 are respectively connected to the installation plate 324 and wheel 31.

In an implementation mode, the number of the guide mechanism 30 provided on the slidable door 20 can be adjusted according to an actual need, and the number of the wheel 31 for each set of guide mechanism 30 can also be adjusted according to actual needs.

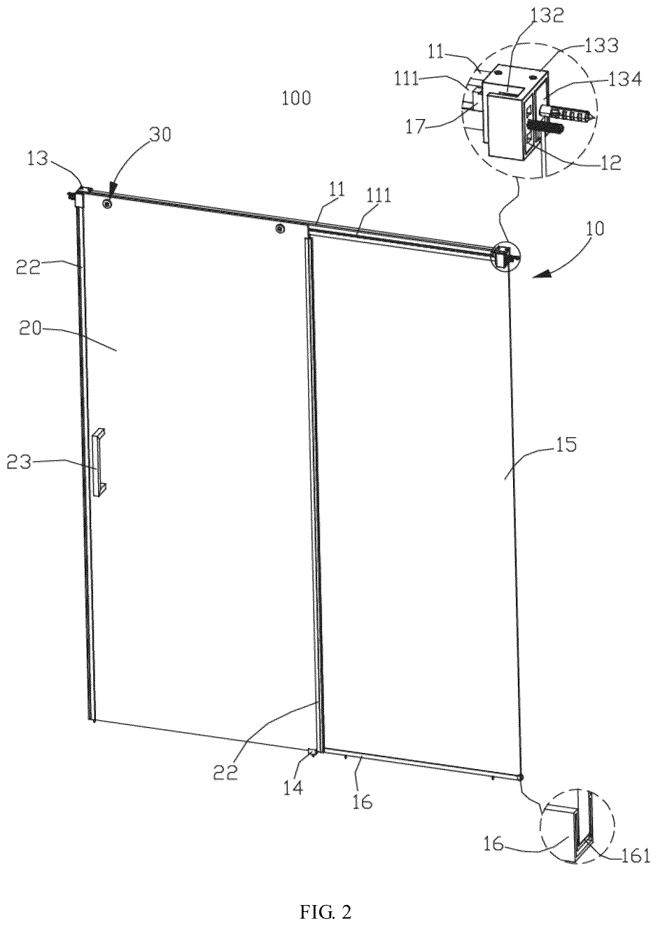

As shown in FIGS. 1 and 2, in order to facilitate a fixing of the fixed rail 11 on an external wall, the fixed mechanism 10 further includes a fixed seat 13 provided at two ends of the fixed rail 11. The fixed seat 13 is provided with an insertion slot 131 corresponding to the fixed rail 11 and an installation slot 132 corresponding to the shock absorbers 12. A shape of the insertion slot 131 should match a cross-sectional shape of the fixed rail 11, and similarly, a shape of the installation slot 132 should match a shape of the shock absorbers 12.

In an implementation mode, the shock absorbers 12 are made of soft material, in an implementation mode, it is made of silicone or rubber.

As shown in FIGS. 2 and 5, the fixed seat 13 includes a seat body 133 and a locking plate 134. The insertion slot 131 and the installation slot 132 are provided on the seat body 133, and the insertion slot 131 penetrates the seat body 133. The shock absorbers 12 are provided in the installation slot 132, the locking plate 134 is fixedly connected to the external wall. The locking plate 134 is detachably connected to the seat body 133. Providing the insertion slot 131 as a through slot can facilitate installation and fixation of the fixed rail 11. During installation, the seat body 133 is sleeved onto the fixed rail 11, and then locking plate 134 is fixed to the external wall with an expansion screw. Finally, the seat body 133 is docked with locking plate 134. In this embodiment, the seat body 133 and the locking plate 134 are locked by a headless screw, and in order to facilitate a positioning of the locking plate 134 and the seat body 133, a positioning slot corresponding to the locking plate 134 should be provided on the seat body 133. In this embodiment, the insertion slot 131 is provided as the positioning slot of the locking plate 134. In other embodiments, a separate positioning slot corresponding to the locking plate 134 can also be provided on the seat body 133. In an implementation mode, to enhance safety, after the seat body 133 is docked with the locking plate 134, the seat body 133 is locked to the fixed rail 11 with the headless screw, which can prevent a relative displacement between the fixed rail 11 and the seat body 133.

In an implementation mode, in order to improve a strength of a connection between the fixed rail 11 and the seat body 133, a reinforcement member 17 is provided at two ends of the fixed rail 11, the reinforcement member 17 is provided in the guide groove 111. The reinforcement member 17 can enhance a strength of the fixed rail 11 and prevent a deformation of the fixed rail 11.

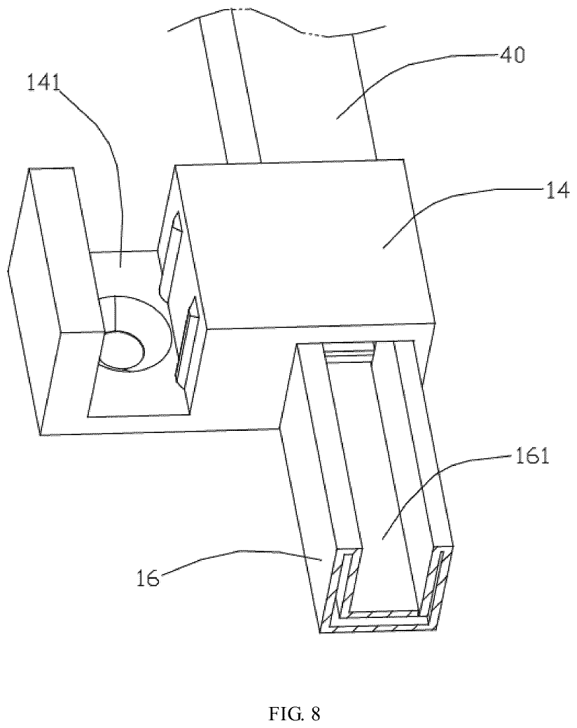

As shown in FIGS. 1 and 8, in an implementation mode, the fixed mechanism 10 further includes a lower fixed seat 14 provided at a bottom of the slidable door 20, a sliding groove 141 corresponding to the slidable door 20 is provided on the lower fixed seat 14. The lower fixed seat 14 can enhance a stability of the slidable door 20 and prevent it from swinging.

In an implementation mode, the frameless hidden wheel slidable door 100 further includes a water blocking strip 40, which is provided on one side of the bottom of the slidable door 20. The water blocking strip 40 can prevent water generated during bathing from flowing out from the bottom of the slidable door 20.

In an implementation mode, two sides of the slidable door 20 are provided with a first waterproof strip 22. The first waterproof strip 22 can improve a sealing performance of this slidable door, thereby preventing water from leaking from edges on two sides of the slidable door 20. In an implementation mode, the first waterproof strip 22 is usually made of elastic material, which can provide a certain buffering effect and protect the slidable door 20.

In an implementation mode, the fixed mechanism 10 further includes a fixed door 15 provided at one end of the fixed rail 11. The fixed door 15 only serves as a partition and does not participate in a function of opening and closing the door. In other embodiments, the fixed door 15 may not be provided with, and the slidable door 20 can be stored inside or on one side of the wall when it is opened. A top of the fixed door 15 is connected to the fixed rail 11, and one side edge of the fixed door 15 abuts against the external wall. In an implementation mode, the fixed mechanism 10 further includes a locking ground rail 16 provided at the bottom of the fixed door 15.

In this embodiment, a first clamp groove 112 corresponding to the fixed door 15 is provided at a bottom of the fixed rail 11, and a second clamp slot 161 corresponding to the fixed door 15 is provided on the locking ground rail 16. The fixed door 15 is fixed by providing with the first clamp groove 112 and the second clamp slot 161. In other embodiments, the fixed door 15 can also be fixed to the fixed rail 11 and the locking ground rail 16 by a fastener, adhesive, or other means.

In an implementation mode, a second waterproof strip 151 is provided on one side edge of the fixed door 15 away from a wall, and a water blocking plate 152 extending towards the slidable door 20 is provided on the waterproof strip. By providing with the second waterproof strip 151 on the fixed door 15 and the water blocking plate 152 extending towards the slidable door 20 on the second waterproof strip 151, water is prevented from flowing out between the fixed door 15 and the slidable door 20, thereby further improving the sealing performance of the slidable door of the present application.

In order to facilitate the opening and closing of the slidable door 20, a handle 23 is provided on inner and outer sides of the slidable door 20. To avoid an interference between handle 23 and fixed door 15, the handle 23 should be placed on one side of the slidable door 20 away from fixed door 15.

In an implementation mode, both slidable door 20 and the fixed door 15 are glass doors. In other embodiments, the slidable door 20 and the fixed door 15 can also be made of materials such as stone, wood, polymer composite materials, etc.

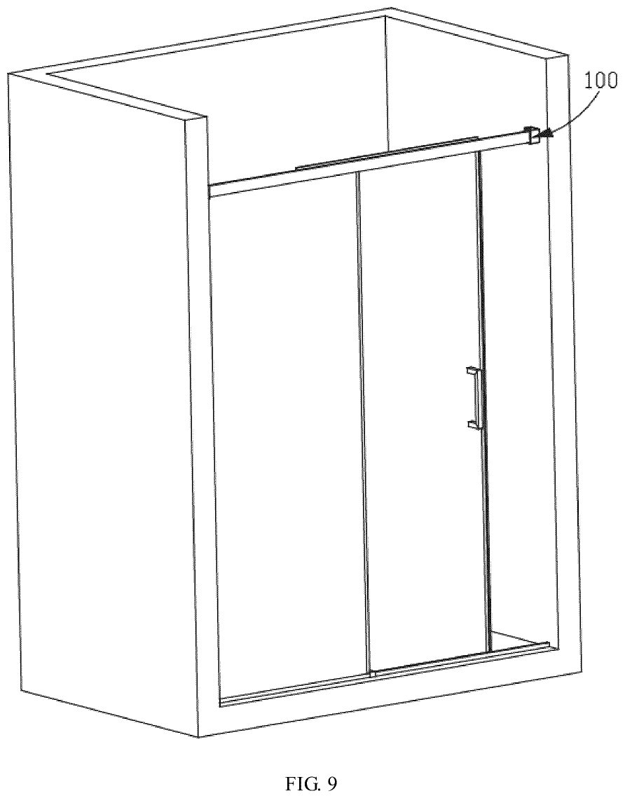

As shown in FIG. 9, it is an application example diagram of the frameless hidden wheel slidable door 100 of the present application. The frameless hidden wheel slidable door 100 is installed at a door opening of the bathroom. During installation, the locking plate 134 is fixed on two sides of the door opening according to an installation position. The wheel 31 can be placed in the guide groove 111 first, and then the fixed rail 11 can be inserted into the insertion slot 131 on the seat body 133. Then, the fixed rail 11 is placed between the two locking plates 134, and the seat body 133 is docked with the locking plate 134. The locking seat body 133 and the locking plate 134 complete an installation of the fixed rail 11. Then, the lower fixed seat 14, the water blocking strip 40, and the locking ground rail 16 are installed in sequence. Then, the fixed door is respectively clamped into the first clamp groove 112 and the second clamp slot 161, and the fixed door 15 is installed. Next, the slidable door 20 is installed. If the wheel 31 is placed in the guide groove 111 in advance, the slidable door 20 is close to the fixed rail 11 and the wheel 31 is fixed to the installation seat 32 with the locking screw 327. Or the wheel 31 can be installed on the slidable door 20 first, and then fastened into the guide groove 111 to complete an installation of the slidable door.

The frameless hidden wheel slidable door 100 of the present application changes the traditional bathroom door with frames on two sides and adopts a unique hidden design of the wheel 31. Its overall shape is simple and beautiful, thereby saving more space. By providing with the water blocking strip 40 at the bottom of the slidable door 20, the first waterproof strip 22 on two sides of the slidable door 20 and the second waterproof strip 151 on the edge of the fixed door 15, a shower waterproofing effect has been improved. Adopting a push-pull system to open and close a door, it is more convenient and reflects a highly humanized design. The door opening has no side frame on both sides, allowing for easy entry and exit, rendering it more convenient for hygiene and cleaning.

Finally, it should be noted that the above description is only preferred example of the present disclosure and is not intended to limit the present disclosure. Although the present disclosure has been described in detail with reference to the aforementioned embodiments, it is still possible for those skilled in the art to modify the technical solutions described in the aforementioned embodiments or replace some of the technical features with equivalent modifications. Any modifications, equivalent substitutions, improvements, etc. made within the spirit and principles of the present disclosure shall be included in the protection scope of the present disclosure.

1. A frameless hidden wheel slidable door, comprising a fixed mechanism and a slidable door,
wherein the fixed mechanism comprises a fixed rail and shock absorbers provided at two ends of the fixed rail; one side of the fixed rail is provided with a guide groove along a length extension direction,
the slidable door is slidably connected to the guide groove, the shock absorbers are provided with a limit groove corresponding to the slidable door;
the frameless and hidden wheel slidable door further comprises a guide mechanism that is connected to the slidable door and the guide groove;
the guide mechanism comprises at least one wheel that is slid and cooperated with the guide groove and an installation seat that is connected to the slidable door and the at least one wheel;
the at least one wheel is provided on one side of the slidable door, the installation seat comprises an adjustment block and a connection shaft;
the slidable door is provided with an adjustment hole that is cooperated with the adjustment block,
the connection shaft is eccentrically provided with the adjustment block;
one end of the connection shaft that is far away from the adjustment block is connected to the at least one wheel;
wherein the installation seat further comprises a fixed plate and an installation plate,
the fixed plate is connected to one end of the adjustment block away from the at least one wheel,
the installation plate is connected to the one end of the connection shaft away from the adjustment block,
the installation plate is provided with the at least one wheel,
diameters of the fixed plate and the installation plate are larger than a diameter of the adjustment hole;
wherein the connection shaft is connected to the adjustment block by a locking screw.

2. (canceled)

3. The frameless hidden wheel slidable door according to claim 1, wherein the fixed mechanism further comprises fixed seats provided at two ends of the fixed rail, and the fixed seats are provided with an insertion slot corresponding to the fixed rail and an installation slot corresponding to the shock absorbers.

4. The frameless hidden wheel slidable door according to claim 3, wherein the fixed seats comprise a seat body and a locking plate,
the insertion slot and the installation slot are provided on the seat body, and the insertion slot penetrates the seat body,
the shock absorbers are provided in the installation slot,
the locking plate is configured to be fixedly connected to an external wall, and the locking plate is detachably connected to the seat body.

5. The frameless hidden wheel slidable door according to claim 1, wherein the fixed mechanism further comprises a lower fixed seat provided at a bottom of the slidable door, and the lower fixed seat is provided with a sliding groove corresponding to the slidable door.

6. The frameless hidden wheel slidable door according to claim 5, further comprising a water blocking strip, which is provided on one side of the bottom of the slidable door.

7. The frameless hidden pulley slidable door according to claim 1, wherein two side edges of the slidable door are provided with a first waterproof strip.

8. The frameless hidden wheel slidable door according to claim 4, wherein the fixed mechanism further comprises a fixed door provided at one end of the fixed rail, a top of the fixed door is connected to the fixed rail and one side edge of the fixed door is configured to abut against the external wall.

9. The frameless hidden wheel slidable door according to claim 8, wherein the fixed mechanism further comprises a locking ground rail provided at a bottom of the fixed door.

10. The frameless hidden wheel slidable door according to claim 8, wherein one side edge of the fixed door away from the wall is provided with a second waterproof strip, and the second waterproof strip is provided with a water blocking plate.
